(19) United States
(12) Patent Application Publication
(10) Pub. No.: US 2006/0147881 A1
(43) Pub. Date: Jul. 6, 2006

(54) Multi-functional dental post

(76) Inventor: Peter Winter-Moore, Dorridge (GB)

Correspondence Address: BOURQUE & ASSOCIATES, P.A., 835 HANOVER STREET, SUITE 301, MANCHESTER, NH, 03104, US

(21) Appl. No.: 10/546,880

(22) PCT Filed: Feb. 23, 2004
(86) PCT No.: PCT/GB04/00720

§ 371 Date: Oct. 5, 2005

(30) Foreign Application Priority Data
Feb. 26, 2003 (GB) 0304303.1
Dec. 9, 2003 (GB) 0328433.8

(51) Int. Cl. A61C 5/08

(52) U.S. Cl. 433/225; 433/220

(57) ABSTRACT

A multi-functional dental post (11) has a transfer coping (13) head, for impression moulding, a core for crown or cap (21) support—with an optional extension filament (12), to fill a tooth root apex; the core can be milled from an integral transfer coping by CAD/CAM techniques.

This invention relates to restorative or reconstructive dental surgery, and attendant surgical instruments, surgical components and surgical methodology.

Dental Reconstruction

A particular instance is tooth replacement, substitution, re-building, re-constitution or reconstruction.

Prefacing tooth failure may arise from, say, accidental impact fracture, hard biting, wear fatigue or decay.

Reconstruction principally concerns unification of an artificial crown or cap—effectively a substitute upper tooth—with a residual natural root stub.

This in turn requires attention to the nature and action of natural teeth, summarised in Appendix A.

Tooth Strength

Teeth are subjected to severe loads, especially shear stresses, under natural jaw movement.

Reconstruction

Thus reconstructive techniques must adapt to or reflect particular tooth type and match the robustness of natural tooth tissue.

The nature of tooth breakage or failure is also a factor.

A joint or connection at an interface between residual natural root stub and artificial crown must be able to withstand shear stresses attendant jaw action.

Overall, a broken tooth can be reconstructed to reproduce or replicate the form and function of an original natural tooth—and so substitute and compensate for its loss or degradation.

Root Treatment

Reconstruction is generally prefaced by root treatment, under local anesthetic for tooth nerve removal and replacement by a root filling.

Subsidiary aspects of the invention address such root fill.

Appearance & Function

A natural tooth profile is necessary to reinstate original form for
aesthetic appearance; and
function, such as biting and chewing in co-operative action with other teeth under jaw movement.

This in turn requires considerable strength and bracing, along with a tough casing or shell to endure grinding and rubbing wear contact.

Mounting

Corresponding strength and security is also required in replacement tooth mounting.

A bonded contact interface helps transfer loads to the original tooth core and root stub foundation.

Some drilling of a residual tooth (root) stub and tooth surface contour re-profiling may be entailed.

Foundation, Crown & Joint

Traditional tooth reconstruction relies upon:
a foundation in a residual natural tooth remnant or root;
an artificial crown or cap to sit upon the root foundation, replicate an original but lost tooth portion and fit with surrounding teeth;
a joint or bridge between natural root foundation and artificial crown;
   Implant

Absent (or upon removal of) a residual root stub, an artificial foundation can be contrived through an implant.

Post

A common jointing element for support and bracing a replacement artificial crown is a (central) mounting pillar or post upstand.

Such a (dental) post serves as an artificial spine, embedded in a residual natural tooth stub or root.

A substitute tooth body is built upon this spine post.

Initially, an artificial tooth is built upon an artificial core at the head of a spine post.

The core can be of an alloy mix and is concealed within a shell—called a crown or cap—which replicates natural tooth appearance, including colour tone.

Typically in an enamel formulation is used by dental technician skill and judgement for a crown.

Dental Post Foundation

Security of dental post foundation in a natural root stub and attachment to an artificial cap are prime considerations for permanence.

This in turn requires a combination of bonding and filling, having first defined an appropriate mounting hole for a post.

Regular, well-defined, and compatible mounting hole and post profiles are required.

The basis for the mounting hole is a natural tooth (root) canal—but which must be enlarged, extended and straightened.

A stepped mounting hole profile is preferred to allow additional peripheral surrounding infill between post and hole upon post emergence at the root top and prospective crown or cap base.

Under good general engineering practice, a target mounting hole diameter is created in successive incremental drilling stages.

This is achieved by a family of progressive diameter drill sizes—with a final surface finishing reamer.

Finished mounting hole diameter reflects:
tooth size and
target post diameter.

Minimal tolerance is sought between mounting hole and post to admit a cement filler and bonding agent upon final installation.

In traditional dental re-construction techniques, separate posts are used respectively for initial crown location and as a basis for mounting a replacement cap.

Traditional impression posts are made from plastics material and feature a modestly enlarged post (top) end to aid post placement and manipulation.

Upon impression post fitting, it is necessary faithfully to map the root contact mounting surface or interface with a prospective crown or cap.

To this end a mouth impression is taken in a dental silicone mould (slab), in which the post (top) end (retentive) core is embedded—as a location reference for crown construction.

Replication

Absent a photographic model, or better still, X-ray of original teeth, some discretion or ‘artistic licence’ is admitted in tooth re-creation.

This takes account of characteristic tooth forms in a given location, but adapted to the individual scale, form and layout of a particular mouth, for which remaining—especially immediately neighbouring and bounding—teeth give some reference.

Individual tooth reconstruction requires faithful replication of an original whole tooth—which will look a credible match with remaining, and in particular neighbouring teeth.

Artistry & Science

This requires a combination of artistry and science by a skilled dental technician—typically working remotely of the patient in a dental laboratory.

Model

A technician creates a mouth model of remaining natural teeth—in particular the surface contour of the residual broken root, with which a cap or crown has to be mated, and alignment of a post mounting hole.

Various tooth cap or crown mounting post designs and attendant methodologies are currently available.

Typically some preparatory drilling and profiling is undertaken to create a post mounting channel, generally starting from, and aligned with, a natural tooth root canal.

Impression Post

Having created an appropriate foundation hole in the remnant tooth, an impression or ‘dummy’ (core) post is employed as a location marker.

Once in situ, this impression post is used to make a location impression in a moulding gel.

The impression provides an axial mounting reference location in an overall mouth mould for a reconstituted tooth.

Plastics Dummy Post—Lost Wax Casting

An example impression post is of synthetic plastics.

This is substituted with a permanent metal post, using a so-called ‘lost wax’ investment casting technique.

A metal cast replica mounting stub post—desirably with enlarged foundation head core—is thus created.

This in turn is a basis for a replica crown of appropriate appearance and wear properties.

This post-mounted replica is (re-)fitted and bonded to the tooth mounting hole.

The original impression post is discarded in such traditional techniques—and as such represents an interim measure.

Post Prior Art

The Applicants earlier proposals for post crowns are set out in an article published in the November/December 1983 issue of Dental Update—jointly authored with Fernando J Sanchez.

The Everest Post System—as discussed in this article—employs two prefabricated inlays;
a coronal inlay of knurled brass; and
a helical stainless steel ‘file’ inlay.

These two elements are inserted into a tooth (stub) and united by a dual thread that permits irreversible locking after cementation.

The stainless steel ‘file’ closes the root canal, but provides support for a replacement crown.

In practice, post insertion represents a continuation of so-called root canal therapy.

This system is also addressed in GB2117641 and U.S. Pat. No. 4,515,565.

Another known post system is the PARA POST of Coltene Whaledent Inc.—as set out in U.S. Pat. No. 5,094,618.

PARA POST uses an elongated cylindrical rod, with intermittent thread segments and passive intervening lands to engage a ‘dead’ (ie root removed) tooth stub.

Failure Prone

However, such known post systems are prone to failure, variously due to:
weakness of casting—leading to fracture;
weakness and ‘leakage’ of plastics cores;
inaccuracy of reproduction of tooth and root canal structure in dental laboratory—leading to ill-fitting crowns with poor retention;
failure of root fillings at tooth apex, due to poor sealing.
   Statement of Invention

According to one aspect of the invention a (multi-function or multi-role) dental post is configured for use
in taking a tooth impression and
as a crown support.

In use, the post is used initially as an impression ‘(up) stand’, then removed for crown building, and finally re-inserted and bonded in situ as a permanent fitting.

Post re-use obviates use of a separate impression post or dowel as in conventional techniques.

Temporary Post

As an interim measure, between root treatment and post-mounted crown fitting, a temporary post and temporary filler bond is used.

This bond is broken to allow temporary post removal, preparatory to cap fitment.

Post Head—Transfer Coping

A locally enlarged post head, or transfer coping, ensures accurate location in an impression.

If suitably re-profiled (say, by CAD/CAM techniques), the head may also serve as a basis (or core) for crown modelling.

Particular attention is paid to post ongoing retention and (re-)use.

A core is created upon or from a post head.

This core may be achieved by re-profiling the existing transfer coping.

In turn, a crown or cap is fitted upon the core.

Thus, a bespoke post stem and ‘transfer coping’ post head profile are adopted for use throughout.

Demountable

A demountable ‘transfer coping’ could be contemplated provided a sufficiently secure, but releasable, joint could be contrived.

Overall, the intention is to contrive a robust location reference upon impression taking and as a foundation core for crown fabrication.

Root Extension

An optional lower extension or tail may be fitted to facilitate filling a base apex of a root canal.

An extension could be of synthetic plastics element.

Such a variant post would serve variously as a(n):
impression aid;
post foundation to support superstructure;
root filling.
   Methodology

According to a further aspect of the invention, a method of tooth reconstruction comprises the steps of:
forming a mounting hole in a root stub;
fitting a post with a transfer coping head into the mounting hole;
making a mouth impression in a moulding mass, with the transfer coping as a location reference;
impression and post removal;
transfer coping removal and substitution with a core—or, optionally, creating a core from a retained, but re-profiled, transfer coping;
fabricating a tooth cap or crown upon the core;
re-instating the post with core and surmounting tooth cap or crown;
cementing the post in situ with bonding and filler in a final installation.
   Outcome

Strength and accuracy are improved, yet methodology simplified—reducing time and effort, but without compromising quality.

### EMBODIMENTS(S)

There now follows a description of some particular embodiments of dental posts and crown (re-) construction and installation of the invention, by way of example only, with reference to the accompanying schematic and diagrammatic drawings, in which:

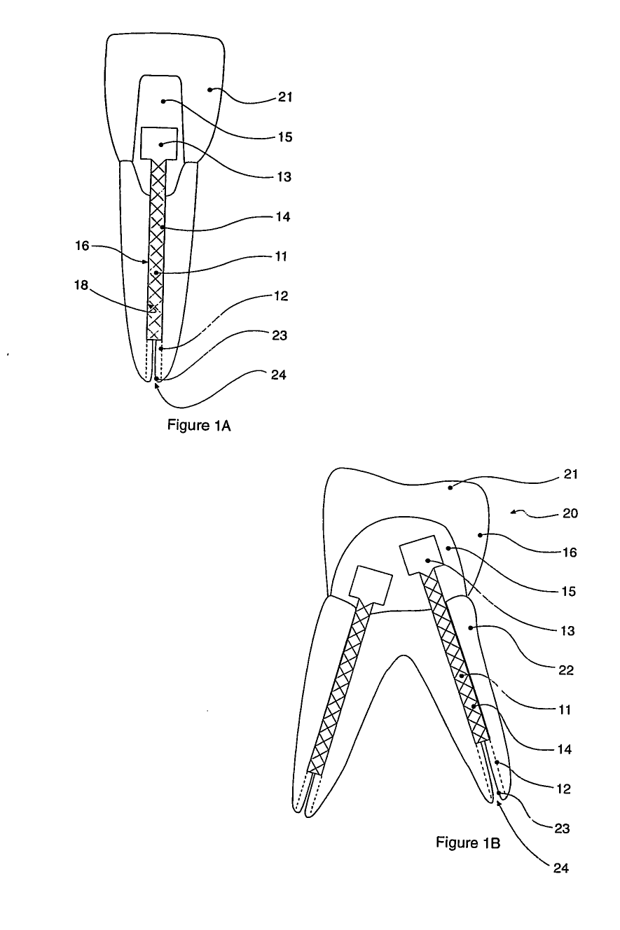

FIGS. 1A and 1B show vertical sections of dental post installations, with a ‘generic’ enlarged post head or so-called ‘transfer coping’ of the present invention upon narrow-rooted teeth;

Such a generic head admits of some variation in outer profile and post fit.

It is generally more substantial at the outset (than a conventional post) and plays an ongoing part in, and (largely) remains after, tooth reconstruction.

That said, its size and form admits of re-profiling, by say machining down, to a somewhat lesser, or at least more ‘tooth conformal’ form—but which can still serve as an inner core for a surmounting crown.

Permanent or demountable post head options can be contemplated—provided they do not introduce slack or play.

A multi-part transfer coping could allow a permanent stub and a removable impression portion.

More specifically,

FIG. 1A shows dental post fitment to an incisor tooth, with a prominent transfer coping as a foundation for a core of a crown or cap;

FIG. 1B shows twin individual dental posts fitted into respective root stems of a double-rooted molar;

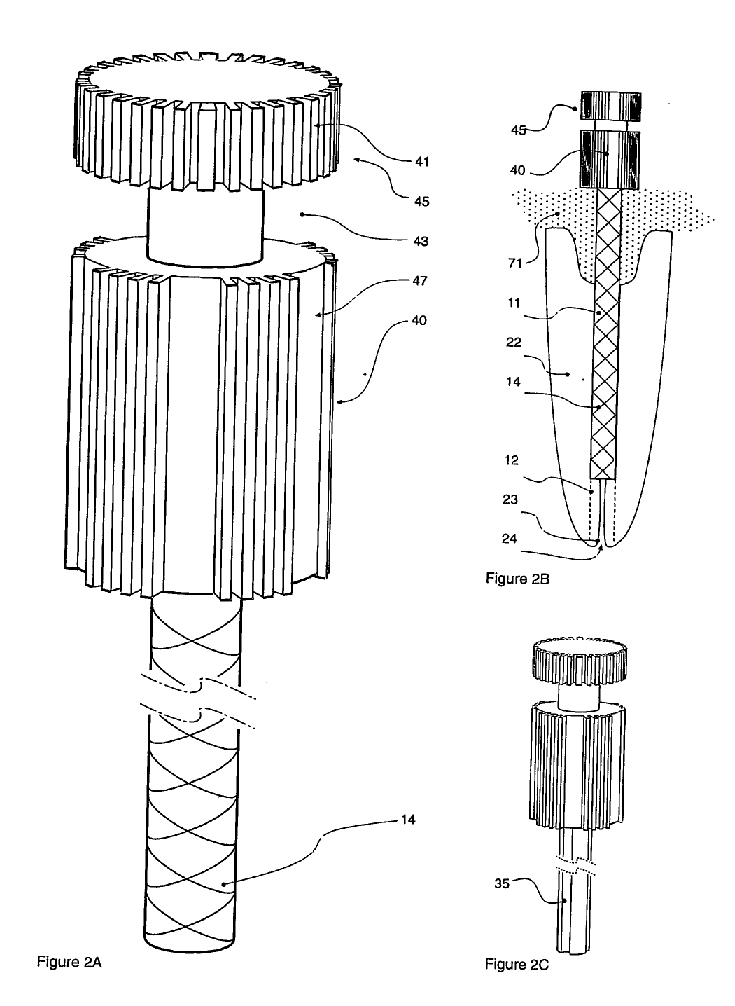

FIGS. 2A through 2C show a particular transfer coping profile;

More specifically,

FIG. 2A shows an enlarged perspective view of a dental post with a ribbed cylindrical barrel head or transfer coping profile and knurled stem or shaft;

{A corresponding profile may be adopted for a hand held drilling or boring mandrel or reamer.}

FIG. 2B shows a vertical section of the post of FIG. 2A installed in a root stub;

FIG. 2C shows an enlarged perspective view of a dental post with a slotted or grooved stem or shaft, fitted with the transfer coping of FIG. 2A;

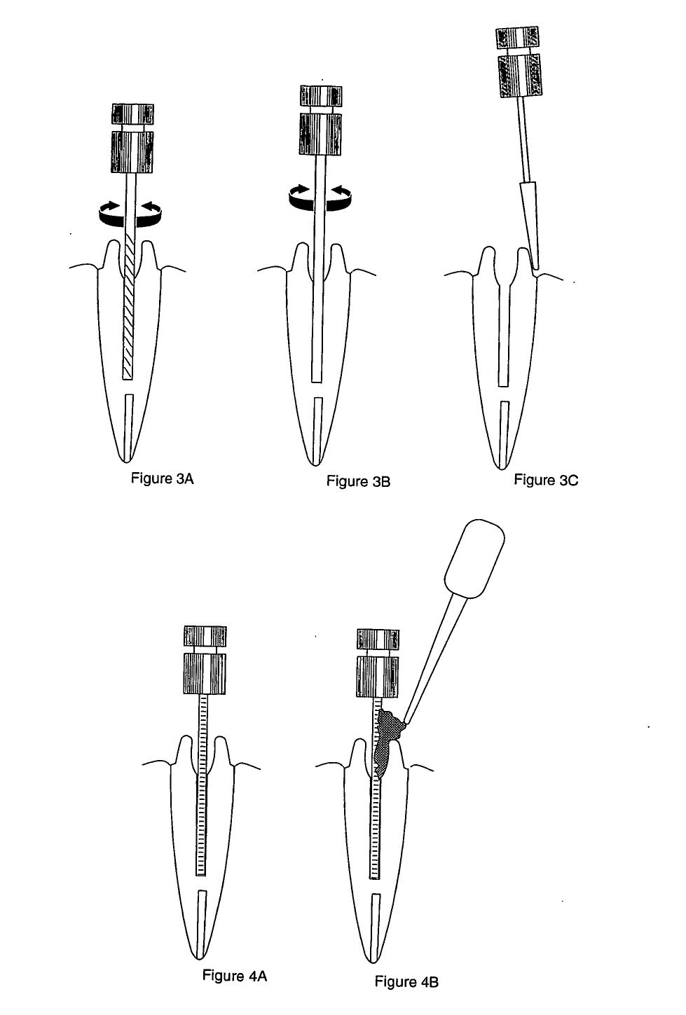

FIGS. 3A through 3C show preparatory mounting hole profiling for a post, such as of FIG. 2;

{Such preparation, includes extending, straightening and progressively enlarging a root canal, using carefully matched drill bits and reamers; along with top edge profiling using a grinding bit.}

FIGS. 4A and 4B show initial impression post fitment in the mounting hole achieved over FIGS. 3A through 3C;

{A close tolerance or snug fit is achieved to minimise lateral play—but which is taken up by a light-bodied (non-binding) silicone gel.}

More specifically,

FIG. 4A shows initial dental post (upright) insertion surmounted by a transfer coping, as a location reference for impression taking;

FIG. 4B shows introduction of a light-bodied silicone gel to secure the post ready for impression taking;

FIGS. 5A and 5B show impression taking (albeit somewhat simplified};

More specifically,

FIG. 5A shows an inserted impression post surrounded by a light-bodied silicone, to make a detailed impression of the post and root stub upper contour, with a heavy-bodied silicone putty on top;

{The prominent post head or transfer coping makes a significant impression and becomes securely buried in the moulding material.

Thus post disposition and orientation are preserved, without risk of inadvertent post dislodgement.

This is particularly important if fitting multiple crowns using a bridge between spaced posts.}

FIG. 5B shows removal of a post along with an impression mould;

{Conventional dental laboratory fabrication techniques can then be employed for crown (re-) construction upon the post.

This same post, or a substitute metal post, may be re-instated once the crown has been created.}

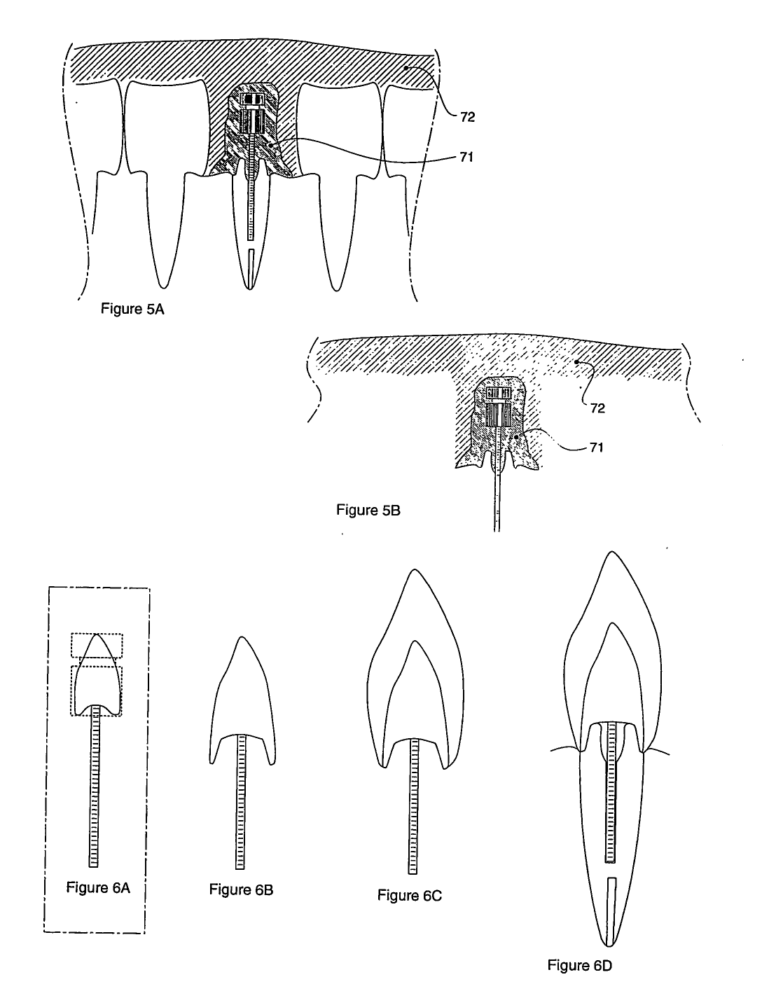

FIGS. 6A through 6D show post head core and crown formation;

More specifically,

FIG. 6A shows an optional stage, of creating a core milled out of an existing transfer coping;

FIG. 6B shows a profiled post head core—either created as in FIG. 6A or cast on after transfer coping removal—as a basis for surmounting crown construction;

{Although a compromise to suit both purposes might be struck, the core is generally of more modest, or at least less pronounced form than that desirable for the transfer coping.

As such the core can be derived from a retained transfer coping, by re-profiling (eg machining).

Alternatively, a demountable transfer coping can be substituted with an appropriate profile core.}

FIG. 6C shows crown construction upon the core of FIG. 6B; and

FIG. 6D shows post and crown (re-)fitment to a subject tooth root stem;

{By virtue of the impression taken, the crown underside profile is a faithful reproduction of the root stub upper form—with a tapered step seat to promote lateral tooth location.}

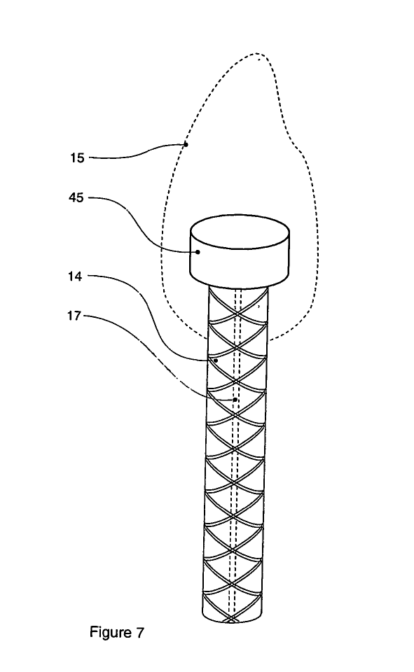

FIG. 7 shows a dummy post for temporary intermediate plug fitment in the course of root treatment, preparatory to tooth reconstruction through a cap or crown;

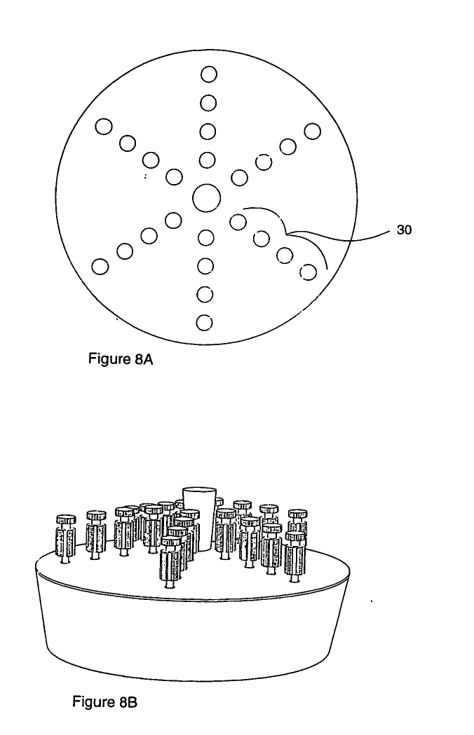

FIGS. 8A and 8B depict respectively plan and perspective views of an installation instrument kit for the multi-function post and attendant technique according to the invention;

{A set of some six incremental drill and corresponding sized posts with respective transfer copings are presented for ease of access to a dental surgeon undertaking the treatment.

Colour coding could identify sizes.

Such a kit could embrace (lower cost) plastics and (more expensive) metal materials.)

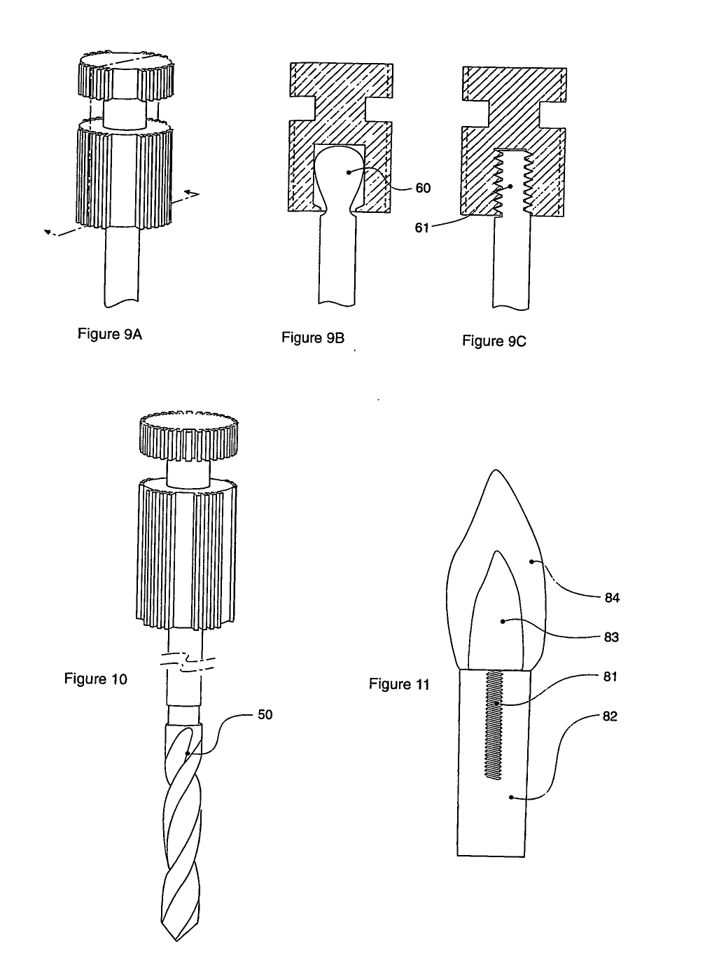

FIGS. 9A through 9C show demountable post heads or transfer copings;

More specifically,

FIG. 9A shows a perspective view of a demountable transfer coping;

FIG. 9B shows the cross-sectional view illustrated in FIG. 9A for a demountable transfer coping upon a post with a bull-nose;

FIG. 9C shows the cross-sectional view illustrated in FIG. 9A for a demountable transfer coping upon a post with a threaded nose;

FIG. 10 shows a hand drill head profile similar to that of a post transfer coping, for ease of finger/thumb grip and manipulation;

FIG. 11 shows a variant threaded post—inserted into an implant or artificial root (such as a cylindrical stub with a threaded mounting hole)—with a milled transfer coping head and surmounting crown or cap.

Referring to the drawings

Post

A dental post 11 is mounted in a residual root stub 22 of a (broken) tooth 20 to support an artificial crown or cap 21.

Post 11 has a knurled shaft or stem 14 located in a specially-prepared mounting hole 16—effectively an extension, straightening and enlargement of a root canal 23.

A substantial, and so prominent, enlarged post head or so-called transfer coping 13 is carried upon post stem 14.

Transfer coping 13 may be a permanent or demountable feature.

Thus it could be, say, a threaded fit or integral.

Metal or plastics material could be employed for post stem 14 and/or transfer coping 13.

Upon final installation, post stem 14 is secured within mounting hole 16 by an intervening bonding and filling cement 18—for which its surface knurling promotes adhesion.

Alternatively, post stem 14 may be of fluted configuration—as illustrated in FIG. 2C.

As depicted in FIG. 1B, for certain teeth—such as molars, with bifurcated root structures—multiple (in this case twin) such posts 11 may be employed for respective root branches or stems.

Post Head—Transfer Coping

At upper end of stem 14—emergent from a root stub 22—post 11 has a transfer coping 13 configured for:
positive location of post 11 into an overall mouth impression mould of dental silicone; and
fabrication (later in a dental laboratory) of a superstructure, featuring an inner core 15 and an outer wear cap or crown 21.

Crown 21 and/or core 15 could be of cast metal, say, using a lost wax casting technique.

Whilst FIGS. 1A and 1B depict a generic transfer coping form—to admit variation—a grooved cylindrical barrel form of FIGS. 2A-2C is preferred.

A circumferential waist slot 43 subdivides the barrel head into an upper head portion 45 and a lower shank portion 40.

Shank 40 is permanently fitted to, or demountable upon a stem 14, with a knurled surface profile to promote bonding and filling within mounting hole 16.

Longitudinal ribs 41 and intervening slots or grooves 42 are grouped between intervening lands 47 to create a greater surface area for impression contact, manual grip and manipulation.

A corresponding profile may be adopted for the handle of a hole profiling drill or reamer (FIG. 10).

Fluted Stem

Alternatively, post 11 stem may be fluted with longitudinal slots 35 to channel cement 18.

Retentive Basket [Transfer Coping]

Although more difficult to fabricate, an open lattice (retentive) basket form (not shown) could be adopted for transfer coping 13, to afford greater contact surface area with an impression silicone.

Such a hollow form of basket 14 allows ingress of dental moulding silicone into its body cavities for accurate location of post 11 in relation to a mouth mould.

Conventional Dummy Post

Hitherto known dental post systems rely upon potentially inaccurate (temporary or intermediate) dummy posts or impression dowels at the impression stage.

Having provided a reference location, such dummy posts are replaced, in a dental laboratory, by permanent—albeit still potentially fragile—cast posts.

Cast posts often fracture in use, whereas pre-fabricated posts, such as adopted in the present case, are demonstrably far more fracture resistant.

Multi-Functional Post

A multi-functional post 11 of the present invention combines:
prefabricated post strength; and
a cast-on-core, stronger than conventional weak cemented core constructions.

Furthermore, because post 11 itself is used to take an impression, the likelihood of distortion, or mis-location, is greatly reduced.

Post Material

In practice, titanium or gold alloy of a suitably high melting point is used for a metal post 11 construction.

This allows a core 15 of lower melting point to be cast upon it, say using a ‘lost wax’ process.

Jewellery fabrication techniques can be used for post and transfer coping construction.

Thus, say, a wrought wire could be used for a knurled post stem 14.

Optional (Root Canal) Extension Filament

Post 11 could be fitted an optional base extension tail or footing, termed a filament 12, in order to fill a root canal 23 at root apex 24.

This would represent a more elongate or protracted post, as a more well founded spinal mounting stem for building upon an artificial crown, discussed later.

This option would address root canal treatment along with crown formation—and so is not applicable where root treatment and fill has already been undertaken as a separate preparatory treatment step.

Filament 12 can be discarded, by simply cutting it off, if there is already a satisfactory root filling.

Plastics Core

A plastics material, such as dental composite or glass ionomer cement, could be cured directly onto post 11 head, to create a suitable core 15.

This could be carried out in a single surgery treatment session.

It would also be an easier technique if a root treatment and a post are needed in a multi-rooted tooth such as a molar (FIG. 1B) or a narrow rooted tooth, such as an incisor (FIG. 1A).

Under conventional techniques this represents a particularly difficult situation to manage.

However, the present invention allows simultaneous completion of root 22 filling and post 11 provision.

Core Fabrication

Transfer coping 13 could serve directly as a core 15—or, duly re-profiled, as the basis for a core 15.

Core material could also cast upon transfer coping 13 and/or post 11 by a lost wax casting process.

Alternatively, a dental composite or glass ionomer cement can be cured upon transfer coping 13 and/or post 11 to create a core 15.

A finishing crown or cap 21 can then be created upon core 15:
in traditional dental materials, such as enamelled porcelain, and
by conventional fabrication techniques

but optionally aided by CAD/CAM technology according to another aspect of the invention.

Instrument Kit Mounting Case

FIGS. 8A and 8B show an instrument kit mounting for implementing installation of a post according to the invention.

Colour coded radial segments 30 accommodate different size post elements.

Demountable Head

FIG. 9B depicts a demountable top fitting transfer coping 13 configured for complementary interfit with a profiled post nose 60.

Nose 60 is somewhat smaller in diameter and of somewhat model domed curvilinear waisted profile, for ease of interaction with the top fitting 13.

FIG. 9C depicts a demountable top fitting transfer coping 13 configured for interfit with a threaded post nose 61.

Transfer Coping Profile

FIG. 2 depicts a preferred transfer coping, configured as a stepped bi-cylindrical form, with longitudinal peripheral grooves or slots 42.

Grooves 42 receive and release silicon impression material and serve as a convenient ribbed grip—for ease of manual (finger/thumb) grip and manipulation.

Intervening retention slots 47 also engage and release silicone barrier film to an impression material (not shown).

This could be used with either wrought metal (say twisted wire) or plastics (impression) posts.

Instruments

FIG. 10 shows a hand drill 50 with a head profile similar to that of the transfer coping 13.

Similarly, other dental instruments—such as reamers or mandrels—may be fitted with like heads.

CAD/CAM

It is envisaged that production of a tooth crown or cap 21—and attendant post head or core (sur)mounting—could employ Computer Aided Design (CAD) and Computer Aided Manufacture (CAM).

Thus a ‘master’ mouth moulding impression could be scanned, say by a surface contact probe or tactile feeler, to create a digital mapped 3-D profile data file.

Post 11 location is precisely determined in relation to that digital map.

The overall mapped picture could be used, say through rapid prototyping techniques, to (re-)create a replacement crown 21 carefully disposed in relation to the recipient mouth and neighbouring teeth.

Crown 21 profiling could be undertaken digitally.

A library of characteristic tooth (crown) forms could be created and stored—as a starting point for adaptation to bespoke profiles for a particular patient mouth.

Similarly, a transfer coping 13 could itself be machined to a suitable core 15 size and form as a basis for a surmounting crown.

Tooth Implants

FIG. 11 shows a variant threaded post 81 inserted into implant 82—which serves as an artificial root.

Post 81 has a core 83, such as an integral milled head or transfer coping, for a surmounting cap 84.

‘Mix and Match’ Features

Generally, in the embodiments, where feasible and appropriate, features may be selectively ‘mixed and matched’ to suit circumstances—albeit it is not feasible to describe every such feature combination.

Bracketed items, vis { . . . }, alongside claim numbering are for ease of reference and form no part of claim interpretation or scope.

Appendix A

Tooth Construction

Essentially, a tooth comprises distinct portions, namely:
Crown—visible above a gum line; and
Root—below gum line, and representing some two thirds overall tooth length.

Being exposed, natural crowns are vulnerable to wear, decay and fracture.

Reconstruction according to the present invention is principally concerned with crown and root interaction.

More specifically, attention is given to the unification of an artificial crown with a residual natural root stub.

A tooth features four different tissue layers, namely:
Enamel—a durable, white covering which protects the tooth from wear and tear of chewing—and indeed is the hardest substance in the body;
Dentin—supports tooth enamel as a yellow bone-like material, softer than enamel and carries nerve fibres able to relay internal tooth condition;
Pulp—tooth centre of soft tissue, with blood and lymph vessels to convey nourishment, and nerves to relay signals to the brain;
Cementum—covers most of the root and helps attach to the jaw bones.

A Periodontal Ligament intervening cushioning layer connects cementum and jawbone.

Tooth Growth & Sustenance

A natural tooth tissue is progressively laid down upon and so ‘grows’ from—and remains anchored to and securely seated in—a jaw bone.

It is a living structure with a root anchor effectively providing a (nutrient) supply line.

There is thus a continuum and integrity of connective tissue from jaw bone seat to tooth crown—whose strength and permanence any artificial substitute crown must reflect.

Tooth Categories

Teeth of different characteristic types or forms are disposed in groups around the mouth, thus:
Incisors—sharpest teeth at the very front of the mouth, shaped to cut food and direct it inward;
Canines—at mouth corners, for grasping and tearing food, with very long roots;
Premolars—just behind Canines, with flatter chewing surface for crushing food;
Molars—last teeth towards mouth back are much larger than Premolars, with greater, flatter chewing surfaces to chew and grind food into smaller pieces.
   Component List
11 dental post
12 filament
13 mounting head/transfer coping
14 knurled stem
15 core
16 mounting hole
17 cement channel
18 cement
20 tooth
21 crown/cap
22 root
23 root canal
24 root apex
30 radial segment
35 slotted stem
40 lower shank portion
41 rib
42 groove
43 waist slot
45 upper head portion
47 land
50 drill
60 post nose
61 screw thread
71 light-bodied silicone
72 heavy-bodied silicone
81 threaded post
82 implant
83 implant core
84 implant crown

1-12. (canceled)

13. A multi-function dental post, configured for positioning, alignment, fabrication and mounting of an artificial tooth crown, comprising: an elongate, generally straight-sided, stem or shank of uniform cross-section, surface marked, and with a longitudinal slot or stem flute, to key a bonding agent; the stem being surmounted by a relatively enlarged head configured as a transfer coping for making a mould impression, with a ribbed circumferential head profile for ease of grip and manipulation, the stem serving as both a temporary positional reference for impression taking and a permanent crown support core and mounting.

14. A dental post of claim 13, with a temporary head for making a mould impression, substituted by a permanent inner mounting core for a crown.

15. A dental post of claim 13, with a head profiled as a ribbed cylindrical barrel, surmounting an axial, generally parallel-sided stem.

16. A dental post of claim 13, with a peripheral head groove, for post retention and/or manipulation.

17. A dental post of claim 13, with a ribbed and grooved head, in conjunction with a knurled stem surface and straight-sided flute to allow bonding agent egress, as an anti-rotational key upon final installation.

18. A dental post of claim 13, with an open lattice or basket head.

19. A dental post of claim 13, with a filamentary extension tail, severable to reach a stub root apex.

20. A dental post of claim 13, demountable upon a post stem.

21. A dental post of claim 13, with a plastics head fused or welded to a metal stem.

22. A dental post of claim 13, with a permanent head, initially profiled for making a mould impression and re-profiled as an inner core for a crown.

23. A cluster of dental posts of claim 13, with respective individual heads or cores, embedded in a common crown, for a stub with multiple root canals.

24. A method of fabricating and installing a tooth crown for tooth reconstruction, for both initial position reference and final installation, comprising the steps of:
providing a dental post with surface marking and a stem flute for bonding agent key, and surmounted by a relatively enlarged head;
pre-drilling a mounting bore of known diameter in a residual tooth stub, by extending and enlarging a root canal;
pre-selecting a pre-machined and pre-surface profiled dental post of matching stem diameter to that of the drill and pre-fitted with an enlarged surmounting head, for making a mould impression;
gripping and manipulating a selected dental post by its head, inserting the post stem as an interference fit into the matching stub bore, for position reference indexing and orientation;
taking a local mouth impression, initially in a soft mass, quick-release, pliant impression gel, faithfully to reproduce stub position, surrounds and upper surface profile;
building up the mould in firmer outer layers, around the post-positioned head as a location reference;
removing the mould with dental post left embedded therein;
installing the post stem in temporary mounting;
locally removing the head and substitution or reconstitution with a permanent core, such as by investment casting;
building up a hard outer crown upon the reconstituted core;
applying a bonding agent, to the post stem and/or stub bore, re-instating the post stem in the matching stub bore to present the complementary profiled core and crown to the stub;
releasing excess bonding agent through the stem flute;
bonding the post permanently in situ using a stem flute as an anti-rotational key.

25. A method of fabricating and installing a tooth crown for tooth reconstruction of claim 24, including the step of re-shaping a stub profile, after drilling and preparatory to initial post fitment for impression making.

26. A method of fabricating and installing a tooth crown for tooth reconstruction of claim 24, with a permanent post head, including the step of re-profiling the head after impression taking, as a core for a crown.

27. A method of fabricating and installing a tooth crown for tooth reconstruction of claim 24, including drilling a stepped mounting bore, with a stepped drill bit or successive different drill bits.

28. A CAD/CAM method of producing a bespoke dental post with integrated core and crown, comprising the steps of:
pre-drilling a post mounting bore in a residual tooth stub;
locally scanning the stub profile and bore position, using a surface contact probe, or tactile feeler;
creating a 3-D contour map as a digital data file;
referencing the digital map of an actual profile to a library of characteristic tooth forms;
building an artificial crown form of profile bespoke to the target location by rapid prototyping, or CAD machining a matched stem mounted core.
